(19) United States
(12) Patent Application Publication
(10) Pub. No.: US 2026/0015813 A1
(43) Pub. Date: Jan. 15, 2026

(54) BIO-BASED LINER MAT FOR WASTE PIT

(71) Applicant: Saudi Arabian Oil Company, Dhahran (SA)

(72) Inventors: Meaad Mohsen Baabdullah, Thuwal (SA); Nouf AlJabri, Dhahran (SA); Khalid Hazazi, Thuwal (SA)

(21) Appl. No.: 18/769,962

(22) Filed: Jul. 11, 2024

(51) Int. Cl. E02D 31/00; B32B 9/02; B32B 9/04

(52) U.S. Cl. CPC E02D 31/004; B32B 9/02; B32B 9/045; B32B 2307/50; B32B 2307/724; B32B 2307/7376; B32B 2367/00; B32B 2398/00

(57) ABSTRACT

A liner mat for waste pit management and drilling fluid recycling at well sites is described. The liner mat includes an adsorbent layer and a base layer. The adsorbent layer includes chitosan and polyhydroxyalkanoate (PHA). The base layer includes polylactic acid (PLA). In some cases, the base layer includes hydroxyapatite (HAp). The adsorbent layer contacts the drilling fluid. The adsorbent layer can mitigate microbial growth and adsorbs at least a portion of pollutants from the drilling fluid. The base layer provides structural support and resistance against mechanical stress and tearing.

### TECHNICAL FIELD

This disclosure relates to drilling waste management and drilling fluid recycling at well sites.

### BACKGROUND

Drilling fluids are used in oil and gas drilling to assist with lubricating the drill bit, ensuring well safety, forming filter cakes to minimize fluid loss into drilling formations, and transporting drill cuttings (such as rock debris) to the surface of the well. As such, drilling fluids are integral to the drilling process. Drilling fluids can include, for example, a water-based mud (WBM) or an oil-based mud (OBM). For WBM, the base fluid can be, for example, water. For OBM, the base fluid can be, for example, diesel. Drilling fluids can include additives, such as surfactants, clay, xanthan gum, and starch, which can enhance fluid properties (such as viscosity and density) and improve overall performance of such drilling fluids (for example, mitigate and/or eliminate the risk of forming a mud cake). In some cases, WBM can be preferable over OBM, for example, due to costs and environmental impacts. Drilling fluids that return to the surface can often contain hydrocarbons, drill cuttings, chemicals, and debris. In accordance with environmental standards, such drillings fluids are typically treated prior to disposal. Treatment of drilling fluids can include, for example, cuttings recovery and decontamination to reduce pollutants in the fluids (for example, using adsorption technologies). After treating the drilling fluid, the drilling fluid can be disposed, for example, in a landfill disposal. In some cases, particularly in remote areas of the world, drilling fluids are discharged into ponds at the rig site with minimal treatment.

### SUMMARY

This disclosure describes technology relating to a liner mat that can be used for drilling fluids waste management and potential drilling fluid reutilization at well sites, for example, for cementing work or for building up pressure. The subject matter described in this disclosure can be implemented in particular implementations, so as to realize one or more of the following advantages. The liner mat can be placed in a waste pit that receives drilling fluid that has flowed through a wellbore formed in a subterranean formation. The drilling fluid can include mud, water, hydrocarbons, trace metals, synthetic and/or natural polymers, as wells as various trace metals (for example, lead) and other pollutants. The liner mat includes a first (adsorbent) layer and a second (base) layer. The adsorbent layer provides filtration and removal of undesired species from the drilling fluids by adsorption, diffusion, or both. The base layer provides mechanical strength to the liner mat. The adsorbent layer includes chitosan and a polyhydroxyalkanoate (PHA). The base layer includes polylactic acid (PLA) and hydroxyapatite (HAp). The adsorbent layer comes into contact with the drilling fluid, and the base layer comes into contact with the waste pit. The described liner mat can remove at least a portion of (for example, some or all) pollutants from drilling fluid, thereby maximizing the potential to reutilize drilling fluid. Implementation of the described liner mat can potentially eliminate uncontrolled disposal of barrels of drilling fluid and drilling waste from oil and gas operations by allowing for drilling fluid reutilization made possible by the liner mat. Chitosan can act as a chelating agent that selectively binds some metals, mitigates microbial growth, and absorbs at least a portion of chemical pollutants in drilling fluids due to the presence of amino groups (—NH₂) and hydroxyl groups (—OH). PLA can impart durability, mechanical strength, and thermal plasticity to the liner mat. PHA is hydrophobic and can remove at least a portion of heavy metal ions (such as lead ions and cadmium ions) from drilling fluids. To an extent, the described liner mat is reusable in that the liner mat can be rinsed and reused in the waste pit to continue treating drilling fluid. Further, the described liner mat is made of biodegradable, biocompatible, and sustainable materials, which can be desirable in comparison to conventional liner mats that are not made of such materials. The described liner mat can serve as a barrier between an external environment (such as soil) and drilling fluids, thereby preventing potential chemical impregnation into the soil. The described liner mat is ecofriendly, biodegradable, durable, and does not negatively impact physical properties of the surrounding external environment (such as a land surface).

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an example drilling rig system for a well.

FIG. 2A is a schematic diagram of an example liner mat that can be implemented in the system of FIG. 1.

FIG. 2B is a schematic diagram of an example liner mat that can be implemented in the system of FIG. 1.

FIG. 3 is a flow chart of an example method for waste pit management and drilling fluid recycling at well sites.

### DETAILED DESCRIPTION

This disclosure describes a liner mat and method of use for drilling fluid waste management and potential drilling fluid recycling at well sites. The liner mat is made of a composite bio-based material that may reduce overflow drilling waste. The composite bio-based material includes multiple copolymers that are biodegradable. Some examples of appropriate copolymers that can be included in the composite bio-based material include chitosan, polylactic acid (PLA), polyhydroxyalkanoates (PHAs), and hydroxyapatite (HAp). The liner mat can be a roll liner mat that can be rolled and unrolled at a desired location. In some implementations, the liner mat includes multiple layers of the composite bio-based material.

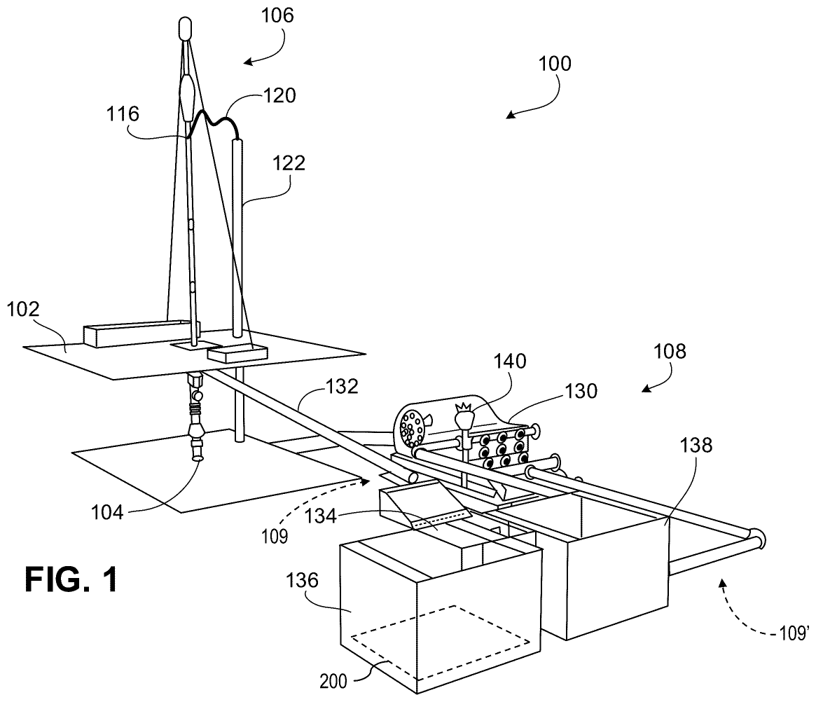

FIG. 1 is a partial schematic perspective view of an example rig system 100 for drilling and producing a well. The well can extend from the surface through the Earth to one or more subterranean zones of interest. The example rig system 100 includes a drill floor 102 positioned above the surface, a wellhead 104, a drill string assembly 106 supported by the rig structure, and a fluid circulation system 108 to filter used drilling fluid 109 from the wellbore. For example, the example rig system 100 of FIG. 1 is shown as a drill rig capable of performing a drilling operation with the rig system 100 supporting the drill string assembly 106 over a wellbore. The wellhead 104 can be used to support casing or other well components or equipment into the wellbore of the well. The example wellhead assembly 104 can take a variety of forms and include a number of different components. For example, the wellhead assembly 104 can include additional or different components than the example shown in FIG. 1. Similarly, the circulation system 108 can include additional or different components than the example shown in FIG. 1. The drilling fluid 109 can include, for example, a water-based mud (WBM) or an oil-based mud (OBM). For WBM, the base fluid can be, for example, water. For OBM, the base fluid can be, for example, diesel.

During a drilling operation of the well, the circulation system 108 circulates drilling fluid 109 from the wellbore to the drill string assembly 106, filters used drilling fluid 109 from the wellbore, and provides clean drilling fluid 109 to the drill string assembly 106. The example circulation system 108 includes a fluid pump 130 that fluidly connects to and provides drilling fluid 109 to drill string assembly 106 via the kelly hose 120 and the standpipe 122. The circulation system 108 also includes a flow-out line 132, a mud shale shaker 134, a settling pit 136, and a suction pit 138. In a drilling operation, the circulation system 108 pumps drilling fluid 109 from the surface, through the drill string assembly 106, out the drill bit and back up the annulus of the wellbore, where the annulus is the space between the drill pipe and the formation or casing. The density of the drilling fluid 109 is intended to be greater than the formation pressures to prevent formation fluids from entering the annulus and flowing to the surface and less than the mechanical strength of the formation, as a greater density may fracture the formation, thereby creating a path for the drilling fluid 109 to go into the formation. Apart from well control, drilling fluid 109 can also cool the drill bit and lift rock cuttings from the drilled formation up the annulus and to the surface to be filtered out and treated before it is pumped down the drill string assembly 106 again. The drilling fluid 109 returns in the annulus with rock cuttings and flows out to the flow-out line 132, which connects to and provides the fluid to the shale shaker 134. The flow line is an inclined pipe that directs the drilling fluid 109 from the annulus to the shale shaker 134. The shale shaker 134 includes a mesh-like surface to separate the coarse rock cuttings from the drilling fluid 109, and finer rock cuttings and drilling fluid 109 then go through the settling pit 136 to the suction pit 136. The circulation system 108 includes a mud hopper 140 into which materials (for example, to provide dispersion, rapid hydration, and uniform mixing) can be introduced to the circulation system 108.

A liner mat 200 is placed in at least one of the settling pit 136 or the suction pit 138. In some implementations, the liner mat 200 is placed in another type of pit, such as a waste pit formed on the Earth's surface (for example, a pit dug into the ground). Although shown in FIG. 1 as being placed in the settling pit 136, the liner mat 200 can alternatively or additionally be placed in the suction pit 138. In some implementations, a first implementation of the liner mat 200 is placed in the settling pit 136, and a second implementation of the liner mat 200 is placed in the suction pit 138. The liner mat 200 is sized and shaped to fit within the pit in which the liner mat 200 is disposed (such as the settling pit 136, the suction pit 138, or a ground waste pit). In some implementations, the liner mat 200 is sized and shaped to cover an inner surface of the pit (such as the inner bottom wall of the settling pit 136). Although FIG. 1 shows a single implementation of the liner mat 200 placed in the settling pit 136, the system 100 can include multiple implementations of the liner mat 200 in the settling pit 136, in the suction pit 138, or in both the settling pit 136 and the suction pit 138. For example, a first implementation of the liner mat 200 can be placed at the bottom of the settling pit 136, and a second implementation of the liner mat 200 can be placed at a side wall of the settling pit 136. As another example, a first implementation of the liner mat 200 can be placed at the bottom of the settling pit 136, and four additional implementations of the liner mat 200 can be distributed across the side walls of the settling pit 136. As another example, a first implementation of the liner mat 200 can be placed at the bottom of the suction pit 138, and a second implementation of the liner mat 200 can be placed at a side wall of the suction pit 138. As another example, a first implementation of the liner mat 200 can be placed at the bottom of the suction pit 138, and four additional implementations of the liner mat 200 can be distributed across the side walls of the suction pit 138. In cases in which the liner mat 200 is placed in a ground waste pit, the liner mat 200 can be sized and shaped to cover the ground waste pit, such that the drilling fluid 109 comes into contact with the liner mat 200 but is prevented from coming into contact with the ground waste pit. By preventing the drilling fluid 109 from coming into contact with the ground waste pit, the liner mat 200 can prevent the drilling fluid 109 (which can include environmentally hazardous components) from coming into contact with soil (for example, soil impregnation), which can improve/maximize environmental protection.

The liner mat 200 is made of a composite bio-based material that can potentially reduce overflow drilling waste, particularly in wet seasons due to the mat's absorption capability. The liner mat 200 can include multiple layers (for example, double layers) having varying (or the same) thicknesses. The individual layers of the liner mat 200 can perform different functions. For example, a layer of the liner mat 200 can remove pollutants such as trace metals (for example, lead) from the drilling fluid 109 to produce a treated drilling fluid 109′, thereby maximizing recycling capacity of drilling fluids in drilling operations, while another layer of the liner mat 200 provides mechanical structure/strength to the liner mat 200. In some cases, the fluid pump 130 can recycle the treated drilling fluid 109′ up the standpipe 122 through the swivel 116 and back into the drill string assembly 106 to go back into the well.

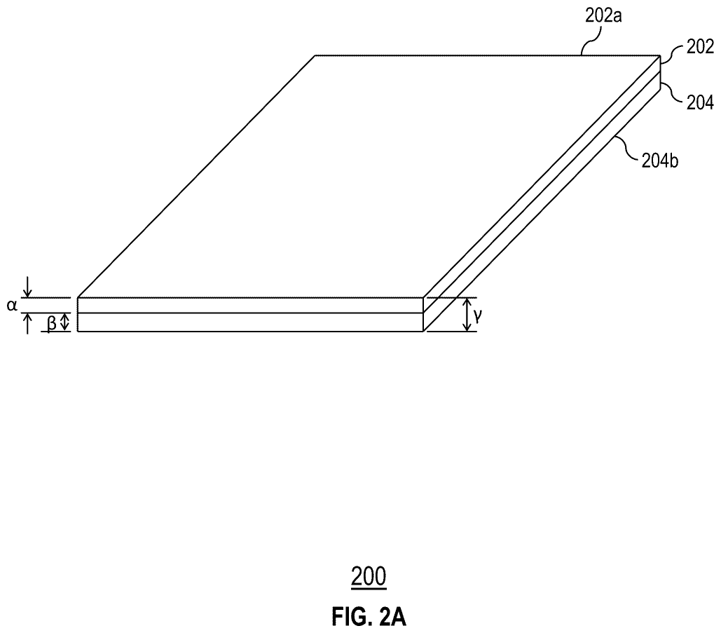

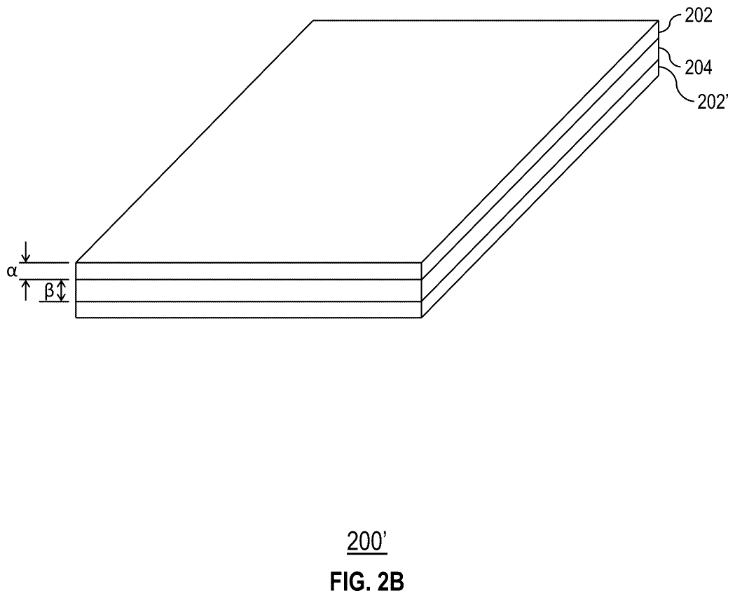

FIG. 2A depicts a schematic diagram of the liner mat 200. The liner mat 200 includes a first layer 202 and a second layer 204. The first layer 202 can be referred to as the adsorbent layer 202. The second layer 204 can be referred to as the base layer 204. The adsorbent layer 202 includes a top surface 202a that is configured to contact the drilling fluid 109. The adsorbent layer 202 includes chitosan and a polyhydroxyalkanoate (PHA). A chitosan content of the adsorbent layer 202 is greater than a PHA content of the adsorbent layer 202. The base layer 204 is coupled to the adsorbent layer 202 at an opposite side of the top surface 202a of the adsorbent layer 202. For example, as shown in FIG. 2A, the base layer 204 is coupled to the bottom surface of the adsorbent layer 202. The base layer 204 includes a bottom surface 204b that is configured to contact the pit (for example, the settling pit 136, the suction pit 138, or a ground waste pit). The base layer 204 includes polylactic acid (PLA) and hydroxyapatite (HAp). The base layer 204 is configured to provide structural support and resistance against mechanical stress and tearing for the liner mat 200. The adsorbent layer 202 is configured to contact the drilling fluid 109, while the base layer 204 is configured to contact the pit (for example, the settling pit 136, the suction pit 138, a ground waste pit, or any combinations of these). The chitosan of the adsorbent layer 202 (in contact with the drilling fluid 109) binds with metal ions, mitigates and/or prevents microbial growth, and adsorbs chemical pollutants (such as heavy metals (for example, lead and cadmium), surfactants (for example, petroleum sulfonate), and polymers (for example, gums, polystyrene, and carbonates)) from the drilling fluid 109. The chitosan of the adsorbent layer 202 includes amino groups (—NH₂) and hydroxyl groups (—OH) which can react with oppositely charged groups of the chemical pollutants, which can potentially remove at least a portion of such chemical pollutants from the drilling fluid 109, thereby allowing re-utilization of the treated drilling fluid 109′.

The PHA has physical features different from the chitosan. For example, the physical state of the PHA of the adsorbent layer 202 can be differentiated by intracellular native PHA granules and partly using crystalline PHA granules. Native PHA granules can have an amorphous appearance which can be attributed to the surface of the granules having a layer of phospholipids and granule-based proteins. The PHA of the adsorbent layer 202 can provide a waterproofing property to the liner mat 200. Further, the PHA of the adsorbent layer 202 can provide increased barrier properties and protect the substrate by ensuring integrity of the structure of the liner mat 200. The PHA of the adsorbent layer 202 is hydrophobic (thus insoluble in water) and binds with metal from the drilling fluid 109, thereby removing the metal (such as heavy trace metals (for example, lead)) from the drilling fluid 109. Thus, the liner mat 200 performs a cleaning function on the drilling fluid 109 to form the at least partially treated drilling fluid 109′, which can be reutilized, for example, for other applications at rig sites. The PLA of the base layer 204 provides mechanical strength, toughness, and thermal plasticity to the liner mat 200.

The PHA included in the liner mat 200 (for example, in the adsorbent layer 202) is a polyester including a monomer. In some implementations, the PHA included in the liner mat 200 (adsorbent layer 202) includes at least one of trimethylbutyrate (3HB), hydrogen peroxide (3HV), 3-hydroxyhexanoate (3HHx), oxygenated octanoate (3HO), 4-hydroxybutyrate (4HB), hydroxydecanoate (3HD), 3-hydroxydodecanoate (3HDD), 3-hydroxy-2-methylbutyrate (3H2 MB), 3-hydroxy-2-methylvalerate (3H2MV), or 3-hydroxypropionate (3HP) as a monomer of the PHA. 3HB as a monomer of the PHA can increase overall biodegradability of the PHA. 3HV as a monomer of the PHA can increase flexibility of the PHA. 3HHx as a monomer of the PHA can increase flexibility of the PHA and enhance the ability of the PHA to bind with (and effectively remove) pollutants from the drilling fluid 109. 3HO as a monomer of the PHA can improve mechanical and thermal properties of the PHA due to 3HO's long hydrocarbon chain. 4HB as a monomer of the PHA can increase hydrophilicity of the PHA. 3HD as a monomer of the PHA can enhance structural variability of the PHA. 3HDD as a monomer of the PHA can increase hydrophobicity of the PHA due to 3HDD's long carbon chain. 3H2 MB as a monomer of the PHA can result in branching of the PHA due to the presence of a methyl group in 3H2 MB, which can alter the characteristics of the resultant PHA. 3H2MV as a monomer of the PHA can improve the mechanical properties of the PHA and improve the PHA's decontamination capability in decontaminating the drilling fluid 109 due to 3H2MV's branching molecular structure. 3HP as a monomer of the PHA can enhance the resultant PHA's overall structure by offering additional functional groups for pollutants in the drilling fluid 109 to interact with to remove such pollutants from the drilling fluid 109 due to the presence of propionate groups in 3HP.

In some implementations, the PHA included in the liner mat 200 (for example, in the adsorbent layer 202) includes poly(3-hydroxybutyrate), poly(3-hydroxybutyrate-co-3-hydroxyvalerate), poly(3-hydroxybutyrate-co-3-hydroxyhexanoate), poly(3-hydroxybutyrate-co-4-hydroxybutyrate), poly(3-hydroxybutyrate-co-3-hydroxyoctanoate), poly(3-hydroxybutyrate-co-3-hydroxydecanoate), or any combinations of these. Poly(3-hydroxybutyrate) is a PHA that can crystallize into a structure that adds mechanical strength to the liner mat 200. Poly(3-hydroxybutyrate-co-3-hydroxyvalerate) is a PHA that is more flexible in comparison to poly(3-hydroxybutyrate) due to the addition of 3-hydroxyvalerate co-polymer units. Poly(3-hydroxybutyrate-co-3-hydroxyhexanoate) is a PHA that is more flexible in comparison to poly(3-hydroxybutyrate) due to the addition of 3-hydroxyhexanoate co-polymer units. Poly(3-hydroxybutyrate-co-4-hydroxybutyrate) is a PHA with enhanced reactivity with water-based components of the drilling fluid 109 in comparison to poly(3-hydroxybutyrate) due to the addition of hydrophilic functional groups. Poly(3-hydroxybutyrate-co-3-hydroxyoctanoate) is a PHA that can further improve the mechanical and thermal properties of the liner mat 200 in comparison to poly(3-hydroxybutyrate) due to the addition of 3-hydroxyactanoate co-polymer units. Poly(3-hydroxybutyrate-co-3-hydroxydecanoate) is a PHA with altered characteristics in comparison to poly(3-hydroxybutyrate) due to the addition of 3-hydroxydecanoate co-polymer units, which can allow for customization in design based on the particular pollutants encountered in the drilling fluid 109.

The PLA included in the liner mat 200 (for example, in the base layer 204) is a thermoplastic polyester with backbone formula [—C(CH₃)HC(═O)O—]ₙ. The molecular weight of the PLA included in the liner mat 200 can be adjusted according to the desired properties of the liner mat 200. In some implementations, the PLA included in the liner mat 200 has an average molecular weight in a range of from about 100,000 Daltons to about 200,000 Daltons. For example, the PLA included in the liner mat 200 can have an average molecular weight of about 100,000 Daltons, about 110,000 Daltons, about 120,000 Daltons, about 130,000 Daltons, about 140,000 Daltons, about 150,000 Daltons, about 160,000 Daltons, about 170,000 Daltons, about 180,000 Daltons, about 190,000 Daltons, or about 200,000 Daltons. Increasing the average molecular weight of the PLA included in the liner mat 200 above about 150,000 Daltons can improve the mechanical properties of the liner mat 200, such as improved modulus, tensile strength, and toughness. Increasing the average molecular weight of the PLA included in the liner mat 200 above about 170,000 Daltons can further improve the mechanical properties of the liner mat 200, but may hinder processability. In some cases, it can be desirable to limit the average molecular weight of the PLA included in the liner mat 200 to be in a range of from about 150,000 Daltons to about 170,000 Daltons (for example, about 160,000 Daltons).

The HAp included in the liner mat 200 (for example, in the base layer 204) is a mineral form of calcium apatite with the formula Ca₅(PO₄)₃(OH), which is sometimes written as Ca₁₀(PO₄)₆(OH)₂ to denote that the crystal unit cell comprises two entities. Inclusion of HAp in the liner mat 200 (for example, in the base layer 204) can improve mechanical structure/stability of the liner mat 200.

The liner mat 200 can be prepared, for example, by extrusion, interfacial polymerization, sputtering, solution casting, phase inversion, or any combinations of these. The materials (such as the chitosan, PHA, and PLA) can be obtained in pelletized or powder form. The materials for the various layers of the liner mat 200 (for example, chitosan and PHA in the adsorbent layer 202, and PLA (and sometimes PHA) in the base layer 204) are measured and blended together in specific ratios to achieve the desired bio-composite characteristics. The materials can be blended, for example, using mechanical mixers or extruders to ensure thorough blending at a molecular level. The blend of polymers can be delivered through an extruder which melts and mixes the polymers through application of pressure and heat. The extruded (e.g., molten) polymer blend can be conveyed by a conveyor system to maintain uniform temperature and prevent degradation of the polymer blend. Consistent flow of the polymer blend can be ensured to maintain uniform processing and uniform resultant characteristics of the bio-composite (resultant liner mat 200). As one example, a converging nozzle can be used to feed the molten polymer blend into a mold via extrusion injection molding. In some cases, a revolving screw is used to ensure sufficient blending of the polymer blend, and in some cases, filler materials (such as mineral fillers (for example, carbonate), fiber reinforcements (for example, carbon fibers), and bio fillers (for example, cellulose)). In cases in which compression molding is implemented, the molten polymer blend can be supplied to a lower mold containing a fiber mat. Pressure can be applied (for example, about 20 kilopascals (kPa)) to compress the molten polymer blend, while ensuring uniform pressure distribution to mold the bio-composite. The molded bio-composite can, for example, be allowed to cool and solidify in an open atmosphere (e.g., ambient conditions). After cooling and solidification, the bio-composite can be cut to desired dimensions (for example, to fit into a waste pit, such as the settling pit 136, the suction pit 138, a ground waste pit, or any combinations of these). In some implementations, the chitosan of the adsorbent layer 202 is grafted and/or crosslinked to enhance stability of the chitosan and mitigate common structural issues, such as swelling. For example, the chitosan of the adsorbent layer 202 can be grafted by a grafting polymer, such as a polycarbamate (for example, polyurethane). Rigorous tests (such as mechanical tests, thermal tests, and dynamic tests) can be performed on the liner mat 200 to evaluate the properties/characteristics of the liner mat 200 to ensure the liner mat 200 is adequate for deployment into the field.

The adsorbent layer 202 provides a primary barrier against the flow of fluids (such as gases and/or liquids). In some implementations, the adsorbent layer 202 has a thickness (α) in a range of from about 0.5 millimeters (mm) to about 20 mm, from about 0.5 mm to about 2 mm, or from about 5 mm to about 20 mm. The base layer 204 acts as a physical barrier and a point of separation between the adsorbent layer 202 the external base (such as the settling pit 136, the suction pit 138, or a ground waste pit). In some implementations, the base layer 204 has a thickness (β) in a range of from about 0.1 mm to about 10 mm, from about 0.1 mm to about 1 mm, or from about 1 mm to about 10 mm. In some implementations, the adsorbent layer 202 is thicker than the base layer 204 (α>β). In some implementations, the base layer 204 is thicker than the adsorbent layer 202 (β>α). In some implementations, the liner mat 200 has an overall thickness (γ) in a range of from about 0.7 mm to about 30 mm.

Although shown in FIG. 2A as including a single adsorbent layer 202 and a single base layer 204, in other implementations, the liner mat 200 can include additional adsorbent layers 202, additional base layers 204, or both. For example, the liner mat 200 can include a single adsorbent layer 202 and multiple implementations of the base layer 204 underneath the adsorbent layer 202 (stacked in a sandwich configuration). As another example, the liner mat 200 can include a single base layer 204 and multiple implementations of the adsorbent layer 202 on top of the base layer 204 (stacked in a sandwich configuration). Including multiple adsorbent layers 202 in the liner mat 200 can be beneficial, for example, especially in cases in which a large variety of pollutants is expected to be encountered. For example, the liner mat 200 may be installed at a site with high contamination levels and complex pollutant mixtures, and including multiple adsorbent layers 202 in the liner mat 200 can be beneficial in providing protection against such pollutants. Further, including multiple adsorbent layers 202 in the liner mat 200 can improve the ability of the liner mat 200 to prevent fluid penetration. Including multiple adsorbent layers 202 in the liner mat 200 can improve the reliability of the liner mat 200 (and the overall system in which the liner mat 200 is installed) because each individual adsorbent layer 202 provides a layer of protection, such that even if saturation or corruption of one of the adsorbent layers 202 occurs, the additional adsorbent layer(s) 202 can still provide barrier protection and cleaning function. Including multiple adsorbent layers 202 in the liner mat 200 can protect against failures that may occur due to unexpected conditions and/or prolonged exposure time. Including multiple base layers 204 in the liner mat 200 can be beneficial, for example, especially in cases in which the liner mat 200 is to be installed in a region of high stress or pressure. Including multiple base layers 204 in the liner mat 200 can enhance the structural integrity of the liner mat 200. Including multiple base layers 204 in the liner mat 200 can help to redistribute weight evenly across the liner mat 200, for example, even in areas with uneven/challenging surfaces. Including multiple base layers 204 in the liner mat 200 can arrest the potential of localized stress concentrations from occurring across the liner mat 200. Including multiple base layers 204 in the liner mat 200 can improve thermal and/or mechanical properties/resistances of the liner mat 200.

Regardless of whether the liner mat 200 includes multiple implementations of the adsorbent layer 202 and/or multiple implementations of the base layer 204, the topmost layer which comes into contact with the drilling fluid 109 is an implementation of the adsorbent layer 202, and the bottommost layer which comes into contact with the waste pit (for example, the settling pit 136, the suction pit 138, or a ground waste pit) is an implementation of the base layer 204. This configuration (topmost layer being an implementation of the adsorbent layer 202 and bottommost layer being an implementation of the base layer 204) is for the liner mat 200 to perform is cleaning function at its topmost layer, while retaining structural integrity/strength at its bottommost layer for preventing leakage of materials and/or fluid through the liner mat 200.

FIG. 2B depicts a schematic diagram of an implementation of the liner mat 200′. The liner mat 200′ is substantially similar to the liner mat 200 shown in FIG. 2A. Similar to the liner mat 200, the liner mat 200′ includes an adsorbent layer 202 and a base layer 204. In contrast to the liner mat 200, the liner mat 200′ includes two implementations of the adsorbent layer 202 (distinctly labeled as 202 and 202′ in FIG. 2B) with the base layer 204 sandwiched between the two adsorbent layers 202, 202′. The adsorbent layers 202, 202′ act as geomembranes to provide a primary barrier against the flow of fluids (such as gases and/or liquids). Having two adsorbent layers 202, 202′ in the liner mat 200′ provides redundancy, which improves reliability in that one of the adsorbent layers 202, 202′ can still provide decontaminating functionality even if the other of the adsorbent layers 202′, 202 fails. Although shown in FIG. 2B as including a two adsorbent layers 202, 202′ and a single base layer 204, in other implementations, the liner mat 200′ can include additional adsorbent layers 202, additional adsorbent layers 202′, additional base layers 204, or any combinations of these. Regardless of whether the liner mat 200′ includes multiple implementations of the adsorbent layer 202, multiple implementations of the adsorbent layer 202′, or multiple implementations of the base layer 204, the topmost layer which comes into contact with the drilling fluid 109 is an implementation of the adsorbent layer 202 or the adsorbent layer 202′, and the bottommost layer which comes into contact with the drilling fluid 109 is an implementation of the adsorbent layer 202 or the adsorbent layer 202′.

In some implementations, the adsorbent layers 202, 202′ have the same composition. In some implementations, the adsorbent layers 202, 202′ have compositions that are different from one another. Having two adsorbent layers 202, 202′ with different compositions from one another can allow for the liner mat 200′ to remove a larger variety of contaminants from the drilling fluid 109. In some implementations, each of the adsorbent layers 202, 202′ have thicknesses (α) in a range of from about 0.5 millimeters (mm) to about 20 mm, from about 0.5 mm to about 2 mm, or from about 5 mm to about 20 mm. The base layer 204 acts as a structural support. In some implementations, the base layer 204 has a thickness (β) in a range of from about 0.1 mm to about 10 mm, from about 0.1 mm to about 1 mm, or from about 1 mm to about 10 mm. In some implementations, the adsorbent layers 202, 202′ are thicker than the base layer 204. In some implementations, the base layer 204 is thicker than the adsorbent layers 202, 202′.

The liner mat 200′ shown in FIG. 2B can be useful, for example, in cases in which the liner mat 200′ can be suspended within (as opposed to being disposed directly on a surface of) the waste pit (for example, the settling pit 136, the suction pit 138, or ground waste pit) in which structural support/protection for an inner wall of the waste pit is not necessary. For example, in cases in which the waste pit is a ground waste pit that is already lined, the liner mat 200′ can simply be suspended within the lined ground waste pit. As another example, in cases in which the waste pit is a structured pit that does not (under normal conditions) leak fluid to its surrounding environment (such as the settling pit 136 and the suction pit 138), the liner mat 200′ can simply be suspended within the structured pit.

In some implementations, the liner mat 200′ is suspended within the waste pit, and omits the adsorbent layer 202′ and the base layer 204. The liner mat 200′ can omit the adsorbent layer 202′ and the base layer 204 in cases in which structural support that is typically provided by the base layer 204 is not necessary due to the conditions within the waste pit. Having a liner mat 200′ that omits the adsorbent layer 202′ and the base layer 204 can reduce the overall weight and cost of the liner mat 200′, which can be a more practical and economical choice for certain installations. The feasibility of omitting a layer (such as the base layer 204) may be contingent on the conditions of the waste pit in which the liner mat 200′ is to be installed. If the waste pit is an outdoor ground waste pit that is not already lined, structural support may be necessary to prevent leakage of drilling fluid 109 (and its contaminants) into the ground. In such cases, omitting the base layer 204 may be disadvantageous. The characteristics and conditions (such as dimensions, stability, and potential mechanical stresses that may be encountered) of the waste pit in which the liner mat 200′ is to be installed should be considered to ensure that the appropriate configuration of the liner mat 200′ is chosen to meet the necessary requirements.

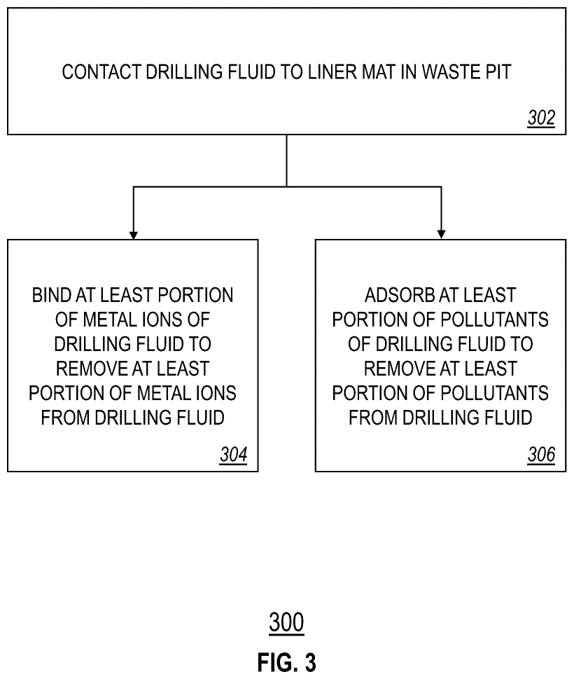

FIG. 3 is a flow chart of an example method 300 for waste pit management and drilling fluid recycling at well sites. The method 300 can, for example, be implemented by system 100 (including liner mat 200) for treating the drilling fluid 109 and producing the treated drilling fluid 109′. At block 302, contacting a drilling fluid (such as the drilling fluid 109) from a well to a liner mat (such as the liner mat 200) disposed in a waste pit (such as the settling pit 136, the suction pit 138, or a ground waste pit). The drilling fluid 109 can include metal ions and pollutants. As described previously, the liner mat 200 includes the adsorbent layer 202 and the base layer 204. The adsorbent layer 202 includes chitosan and a PHA, and a chitosan content of the adsorbent layer 202 is greater than a PHA content of the adsorbent layer 202. The base layer 204 includes PLA and HAp and is in contact with the waste pit. The base layer 204 provides structural support and resistance against mechanical stress and tearing for the liner mat 200. At block 304, the adsorbent layer 202 of the liner mat 200 binds at least a portion of the metal ions of the drilling fluid 109 in response to contacting the drilling fluid 109 to the liner mat 200 (block 302), thereby removing at least the portion of the metal ions from the drilling fluid 109. The chitosan and the PHA of the adsorbent layer 202 can, for example, selectively bind the metal ions of the drilling fluid 109 at block 304. At block 306, the adsorbent layer 202 of the liner mat 200 adsorbs at least a portion of the pollutants of the drilling fluid 109 in response to contacting the drilling fluid 109 to the liner mat 200 (block 302), thereby removing at least a portion of the pollutants from the drilling fluid 109. The chitosan of the adsorbent layer 202 can, for example, adsorb the pollutants of the drilling fluid 109 at block 306. Binding at least the portion of the metal ions at block 304 and adsorbing at least the portion of the pollutants at block 306 produces a treated drilling fluid (such as the treated drilling fluid 109′) that has a decreased content of metal ions and pollutants in comparison to the drilling fluid 109, due to at least the portion of the metal ions and at least the portion of the pollutants remaining bound to the adsorbent layer 202 of the liner mat 200. For example, the treated drilling fluid 109′ can be substantially free of metal ions and pollutants due to the metal ions and pollutants remaining bound to the adsorbent layer 202 of the liner mat 200. The drilling fluid 109 is contacted to the liner mat 200 at block 302 for sufficient time to treat the drilling fluid 109 and produce the treated drilling fluid 109′. For example, the drilling fluid 109 is contacted to the liner mat 200 at block 302 for a time duration that is sufficient for blocks 304 and 306 to occur. In some implementations, the drilling fluid 109 is contacted to the liner mat 200 at block 302 for a time duration in a range of from about 30 minutes to about 10 hours, from about 30 minutes to about 1 hour, from about 1 hour to 2 hours, from about 2 hours to about 4 hours, or from about 4 hours to about 10 hours.

In some implementations, the method 300 includes separating the treated drilling fluid 109′ from the liner mat 200. In some implementations, the method 300 includes reutilizing the treated drilling fluid 109′ from the waste pit for another operation at the rig site, for example, a cementing operation. In some implementations, after separating the treated drilling fluid 109′ from the liner mat 200, the method 300 includes rinsing the liner mat 200 to unbind the metal ions from the liner mat 200 and desorb the pollutants from the liner mat 200. The liner mat 200 can be rinsed, for example, using deionized water or a bio-surfactant, such as rhamnolipids. Rhamnolipids are biodegradable and have extremely low toxicity, making them a green alternative to rinsing agents in other applications. The rinsing fluid used to rinse the liner mat 200 should be chemically compatible with the chitosan-based membrane material of the liner mat 200 and the contaminants bonded to and/or disposed on the liner mat 200. The rinsing fluid used to rinse the liner mat 200 should include components that can solubilize and/or dissolve the contaminant molecules that are bonded to the chitosan of the liner mat 200. The rinsing fluid used to rinse the liner mat 200 typically does not include abrasive material, which could potentially damage the liner mat 200.

Rinsing the liner mat 200 can remove metal ions, pollutants, and solid residues from the liner mat 200. The rinsing fluid facilitates detachment of ions from the chitosan of the liner mat 200 and frees the pollutants captured on the surface of the liner mat 200. Within the porous structures of the liner mat 200, the rinsing fluid can serve both as a solvent and as a dispersing medium. The rinsing fluid dissolves and/or disperses the metal ions, which break the chemical bonding with the chitosan and desorbs the pollutants that are borne from the chitosan matrix. Further, the pH and ionic strength of the chitosan can impact its ability to liberate ions and metals. The rinsing fluid can, for example, include chelating or complexing components, which can facilitate metal ion removal by displacing the weakly held adsorption of the pollutants to the liner mat 200 in favor of the strongly adsorption capability of the rinsing fluid. Rinsing the liner mat 200 can allow for the liner mat 200 to be reused for treating additional drilling fluid 109.

In some implementations, the method 300 includes monitoring (for example, visually) a condition of the liner mat 200 and determining whether the liner mat 200 is ready to be rinsed based on monitoring the condition of the liner mat 200. The liner mat 200 can be monitored to be rinsed and/or replaced to guarantee hygiene and safe water quality. Pollutants/wastes that accumulate odor, color, consistency, biological growth, absorption of water, or any combinations of these can be monitored, for example, as visual cues for starting the rinsing/replacement process. In cases where after multiple rinse cycles, the liner mat 200 has faded in color and/or has accumulated odor, consistency, or biological growth that lingers even after rinsing, it may be necessary to dispose and replace the liner mat 200. Physical damage, compromise in structural integrity, and compliance with manufacturer recommendations can be determining factors in deciding whether to replace the liner mat 200 or replace components of the liner mat 200. Frequent rinsing of the liner mat 200 can potentially prolong the operating life of the liner mat 200. Appropriate and timely disposal and replacement of depreciated liner mats 200 can also ensure safe operation. Regularly monitoring the condition of the liner mat 200 can ensure that the liner mat 200 adequately traps dirt and/or moisture, thereby minimizing slips and improving air quality of the surrounding environment. In cases where a drop (decrease) in microbial activity during a metagenomic analysis of the liner mat 200 is observed, the drop in microbial activity may indicate that the adsorbent layer 202 of the liner mat 200 is no longer functioning properly and therefore failing to decontaminate/treat the drilling fluid 109. In such cases, it may be necessary to dispose and replace the liner mat 200. However, disposal of the liner mat 200 does not impose a large environmental consequence, as the liner mat 200 is made from biocompatible, biodegradable, and sustainable materials.

### Embodiments

In an example implementation (or aspect), a method comprises: contacting, with a liner mat disposed in a waste pit, a drilling fluid that has flowed through a wellbore formed in a subterranean formation, wherein the drilling fluid comprises metal ions and pollutants, wherein the liner mat comprises: a adsorbent layer comprising chitosan and a polyhydroxyalkanoate (PHA), wherein a chitosan content of the adsorbent layer is greater than a PHA content of the adsorbent layer; and a base layer comprising polylactic acid (PLA) and hydroxyapatite (HAp), wherein the base layer is in contact with the waste pit, wherein the base layer is configured to provide structural support and resistance against mechanical stress to the liner mat; binding, by the adsorbent layer of the liner mat, at least a portion of the metal ions of the drilling fluid in response to contacting the drilling fluid to the liner mat, thereby removing at least the portion of the metal ions from the drilling fluid; and adsorbing, by the adsorbent layer of the liner mat, at least a portion of the pollutants of the drilling fluid in response to contacting the drilling fluid to the liner mat, thereby removing at least the portion of the pollutants from the drilling fluid, wherein binding at least the portion of the metal ions and adsorbing at least the portion of the pollutants produces a treated drilling fluid, wherein the treated drilling fluid has a decreased content of metal ions and pollutants in comparison to the drilling fluid due to at least the portion of the metal ions and at least the portion of the pollutants remaining bound to the adsorbent layer of the liner mat.

In an example implementation (or aspect) combinable with any other example implementation (or aspect), the method further comprises: separating the treated drilling fluid from the liner mat; and reutilizing the treated drilling fluid from the waste pit for a cementing operation.

In an example implementation (or aspect) combinable with any other example implementation (or aspect), the method further comprises, after separating the treated drilling fluid from the liner mat, rinsing the liner mat to unbind the metal ions from the liner mat and desorb the pollutants from the liner mat.

In an example implementation (or aspect) combinable with any other example implementation (or aspect), the method further comprises: visually monitoring a physical condition of the liner mat; and determining whether the liner mat is ready to be rinsed based on visually monitoring the physical condition of the liner mat.

In an example implementation (or aspect) combinable with any other example implementation (or aspect), the drilling fluid is contacted to the liner mat for a time duration in a range of from about 30 minutes to about 10 hours.

In an example implementation (or aspect) combinable with any other example implementation (or aspect), the PHA comprises at least one of trimethylbutyrate, hydrogen peroxide, 3-hydroxyhexanoate, oxygenated octanoate, 4-hydroxybutyrate, hydroxydecanoate, 3-hydroxydodecanoate, 3-hydroxy-2-methylbutyrate, 3-hydroxy-2-methylvalerate, or 3-hydroxypropionate as a monomer of the PHA.

In an example implementation (or aspect) combinable with any other example implementation (or aspect), the PHA is selected from the group consisting of poly(3-hydroxybutyrate), poly(3-hydroxybutyrate-co-3-hydroxyvalerate), poly(3-hydroxybutyrate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

In an example implementation (or aspect) combinable with any other example implementation (or aspect), the adsorbent layer has a first thickness in a range of from about 0.5 millimeters (mm) to about 20 mm, and the base layer has a second thickness in a range of from about 0.1 mm to about 10 mm.

In an example implementation (or aspect), a liner mat for waste pit management and drilling fluid reutilization at well sites, the liner mat comprising: a adsorbent layer comprising chitosan and a polyhydroxyalkanoate (PHA), wherein a chitosan content of the adsorbent layer is greater than a PHA content of the adsorbent layer, wherein the adsorbent layer comprises a top surface configured to contact the drilling fluid, wherein the chitosan of the adsorbent layer is configured to mitigate microbial growth and adsorb at least a portion of pollutants from the drilling fluid, wherein the chitosan and the PHA of the adsorbent layer are configured to bind with at least a portion of metal ions of the drilling fluid which is in contact with the adsorbent layer, thereby removing at least the portion of metal ions from the drilling fluid; and a base layer comprising polylactic acid (PLA) and hydroxyapatite (HAp), wherein the base layer is coupled to the adsorbent layer at an opposite side of the top surface of the adsorbent layer, wherein the base layer comprises a bottom surface configured to contact the waste pit, wherein the base layer is configured to provide structural support and resistance against mechanical stress and tearing for the liner mat.

In an example implementation (or aspect) combinable with any other example implementation (or aspect), the PHA comprises at least one of trimethylbutyrate, hydrogen peroxide, 3-hydroxyhexanoate, oxygenated octanoate, 4-hydroxybutyrate, hydroxydecanoate, 3-hydroxydodecanoate, 3-hydroxy-2-methylbutyrate, 3-hydroxy-2-methylvalerate, or 3-hydroxypropionate as a monomer of the PHA.

In an example implementation (or aspect) combinable with any other example implementation (or aspect), the PHA is selected from the group consisting of poly(3-hydroxybutyrate), poly(3-hydroxybutyrate-co-3-hydroxyvalerate), poly(3-hydroxybutyrate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

In an example implementation (or aspect) combinable with any other example implementation (or aspect), the polylactic acid has an average molecular weight of about 1.6×10⁵

### Daltons.

In an example implementation (or aspect) combinable with any other example implementation (or aspect), the first thickness of the adsorbent layer in a range of from about 0.5 millimeters (mm) to about 20 mm, and the second thickness of the base layer in a range of from about 0.1 mm to about 10 mm.

In an example implementation (or aspect), a wellbore drilling system comprises: a waste pit located at a well site; a circulation system at the well site, the circulation system comprising: a fluid pump configured to circulate a drilling fluid through a drill string assembly configured to drill into a subterranean formation to form a wellbore; and a tubular configured to receive the drilling fluid that has been used to form the wellbore and direct the drilling fluid to a liner mat disposed in the waste pit, wherein the drilling fluid comprises metals and metal ions; and the liner mat comprising: a adsorbent layer comprising chitosan and a polyhydroxyalkanoate (PHA), wherein a chitosan content of the adsorbent layer is greater than a PHA content of the adsorbent layer, wherein the adsorbent layer comprises a top surface configured to receive and contact the drilling fluid, wherein the chitosan of the adsorbent layer is configured to mitigate microbial growth and adsorb at least a portion of pollutants from the drilling fluid, wherein the chitosan and the PHA of the adsorbent layer are configured to bind with at least a portion of the metals and the metal ions from the drilling fluid which is in contact with the adsorbent layer, thereby removing at least the portion of the metals and the metal ions from the drilling fluid; and a base layer comprising polylactic acid (PLA) and hydroxyapatite (HAp), wherein the base layer is coupled to the adsorbent layer at an opposite side of the top surface of the first layer, wherein the base layer comprises a bottom surface configured to contact the waste pit, wherein the base layer is configured to provide structural support and resistance against mechanical stress to the liner mat.

In an example implementation (or aspect) combinable with any other example implementation (or aspect), the system further comprises a second tubular configured to direct flow of the drilling fluid from the waste pit back into the wellbore, wherein the drilling fluid flowing through the second tubular is substantially free of metals and metal ions due to the metals and metal ions remaining bound to the adsorbent layer of the liner mat.

In an example implementation (or aspect) combinable with any other example implementation (or aspect), the PHA comprises at least one of trimethylbutyrate, hydrogen peroxide, 3-hydroxyhexanoate, oxygenated octanoate, 4-hydroxybutyrate, hydroxydecanoate, 3-hydroxydodecanoate, 3-hydroxy-2-methylbutyrate, 3-hydroxy-2-methylvalerate, or hydroxypropionate as a monomer of the PHA.

In an example implementation (or aspect) combinable with any other example implementation (or aspect), the PHA is selected from the group consisting of poly(3-hydroxybutyrate), poly(3-hydroxybutyrate-co-3-hydroxyvalerate), poly(3-hydroxybutyrate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

In an example implementation (or aspect) combinable with any other example implementation (or aspect), the polylactic acid has an average molecular weight in a range of from about 1.5×10⁵ Daltons to about 1.7×10⁵ Daltons.

In an example implementation (or aspect) combinable with any other example implementation (or aspect), a first thickness of the adsorbent layer is in a range of from about 0.5 millimeters (mm) to about 20 mm, and a second thickness of the base layer is in a range of from about 0.1 mm to about 10 mm.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A method comprising:
contacting, with a liner mat disposed in a waste pit, a drilling fluid that has flowed through a wellbore formed in a subterranean formation, wherein the drilling fluid comprises metal ions and pollutants, wherein the liner mat comprises:
a adsorbent layer comprising chitosan and a polyhydroxyalkanoate (PHA), wherein a chitosan content of the adsorbent layer is greater than a PHA content of the adsorbent layer; and
a base layer comprising polylactic acid (PLA) and hydroxyapatite (HAp), wherein the base layer is in contact with the waste pit, wherein the base layer is configured to provide structural support and resistance against mechanical stress to the liner mat;
binding, by the adsorbent layer of the liner mat, at least a portion of the metal ions of the drilling fluid in response to contacting the drilling fluid to the liner mat, thereby removing at least the portion of the metal ions from the drilling fluid; and
adsorbing, by the adsorbent layer of the liner mat, at least a portion of the pollutants of the drilling fluid in response to contacting the drilling fluid to the liner mat, thereby removing at least the portion of the pollutants from the drilling fluid, wherein binding at least the portion of the metal ions and adsorbing at least the portion of the pollutants produces a treated drilling fluid, wherein the treated drilling fluid has a decreased content of metal ions and pollutants in comparison to the drilling fluid due to at least the portion of the metal ions and at least the portion of the pollutants remaining bound to the adsorbent layer of the liner mat.

2. The method of claim 1, further comprising:
separating the treated drilling fluid from the liner mat; and
reutilizing the treated drilling fluid from the waste pit for a cementing operation.

3. The method of claim 1, further comprising, after separating the treated drilling fluid from the liner mat, rinsing the liner mat to unbind the metal ions from the liner mat and desorb the pollutants from the liner mat.

4. The method of claim 3, further comprising:
visually monitoring a physical condition of the liner mat; and
determining whether the liner mat is ready to be rinsed based on visually monitoring the physical condition of the liner mat.

5. The method of claim 1, wherein the drilling fluid is contacted to the liner mat for a time duration in a range of from about 30 minutes to about 10 hours.

6. The method of claim 1, wherein the adsorbent layer contacts the drilling fluid, and the base layer contacts a surface of the waste pit.

7. The method of claim 1, wherein the PHA comprises at least one of trimethylbutyrate, hydrogen peroxide, 3-hydroxyhexanoate, oxygenated octanoate, 4-hydroxybutyrate, hydroxydecanoate, 3-hydroxydodecanoate, 3-hydroxy-2-methylbutyrate, 3-hydroxy-2-methylvalerate, or 3-hydroxypropionate as a monomer of the PHA.

8. The method of claim 7, wherein the PHA is selected from the group consisting of poly(3-hydroxybutyrate), poly(3-hydroxybutyrate-co-3-hydroxyvalerate), poly(3-hydroxybutyrate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

9. The method of claim 8, wherein the adsorbent layer has a first thickness in a range of from about 0.5 millimeters (mm) to about 20 mm, and the base layer has a second thickness in a range of from about 0.1 mm to about 10 mm.

10. A liner mat for waste pit management and drilling fluid reutilization at well sites, the liner mat comprising:
a adsorbent layer comprising chitosan and a polyhydroxyalkanoate (PHA), wherein a chitosan content of the adsorbent layer is greater than a PHA content of the first layer, wherein the adsorbent layer comprises a top surface configured to contact the drilling fluid, wherein the chitosan of the adsorbent layer is configured to mitigate microbial growth and adsorb at least a portion of pollutants from the drilling fluid, wherein the chitosan and the PHA of the adsorbent layer are configured to bind with at least a portion of metal ions of the drilling fluid which is in contact with the adsorbent layer, thereby removing the portion of metal ions from the drilling fluid; and
a base layer comprising polylactic acid (PLA) and hydroxyapatite (HAp), wherein the base layer is coupled to the adsorbent layer at an opposite side of the top surface of the adsorbent layer, wherein the base layer comprises a bottom surface configured to contact the waste pit, wherein the base layer is configured to provide structural support and resistance against mechanical stress to the liner mat.

11. The liner mat of claim 10, wherein the PHA comprises at least one of trimethylbutyrate, hydrogen peroxide, 3-hydroxyhexanoate, oxygenated octanoate, 4-hydroxybutyrate, hydroxydecanoate, 3-hydroxydodecanoate, 3-hydroxy-2-methylbutyrate, 3-hydroxy-2-methylvalerate, or 3-hydroxypropionate as a monomer of the PHA.

12. The liner mat of claim 11, wherein the PHA is selected from the group consisting of poly(3-hydroxybutyrate), poly(3-hydroxybutyrate-co-3-hydroxyvalerate), poly(3-hydroxybutyrate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

13. The liner mat of claim 12, wherein the polylactic acid has an average molecular weight of about 1.6×10⁵ Daltons.

14. The liner mat of claim 13, wherein a first thickness of the adsorbent layer is in a range of from about 0.5 millimeters (mm) to about 20 mm, and a second thickness of the base layer is in a range of from about 0.1 mm to about 10 mm.

15. A wellbore drilling system comprising:
a waste pit located at a well site;
a circulation system at the well site, the circulation system comprising:
a fluid pump configured to circulate a drilling fluid through a drill string assembly configured to drill into a subterranean formation to form a wellbore; and
a tubular configured to receive the drilling fluid that has been used to form the wellbore and direct the drilling fluid to a liner mat disposed in the waste pit, wherein the drilling fluid comprises metals and metal ions; and
the liner mat comprising:
a adsorbent layer comprising chitosan and a polyhydroxyalkanoate (PHA), wherein a chitosan content of the adsorbent layer is greater than a PHA content of the adsorbent layer, wherein the adsorbent layer comprises a top surface configured to receive and contact the drilling fluid, wherein the chitosan of the adsorbent layer is configured to mitigate microbial growth and adsorb at least a portion of pollutants from the drilling fluid, wherein the chitosan and the PHA of the adsorbent layer are configured to bind with at least a portion of the metals and the metal ions from the drilling fluid which is in contact with the adsorbent layer, thereby removing at least the portion of the metals and the metal ions from the drilling fluid; and
a base layer comprising polylactic acid (PLA) and hydroxyapatite (HAp), wherein the base layer is coupled to the adsorbent layer at an opposite side of the top surface of the adsorbent layer, wherein the base layer comprises a bottom surface configured to contact the waste pit, wherein the base layer is configured to provide structural support and resistance against mechanical stress to the liner mat.

16. The system of claim 15, further comprising a second tubular configured to direct flow of the drilling fluid from the waste pit back into the wellbore, wherein the drilling fluid flowing through the second tubular is substantially free of metals and metal ions due to the metals and metal ions remaining bound to the adsorbent layer of the liner mat.

17. The system of claim 15, wherein the PHA comprises at least one of trimethylbutyrate, hydrogen peroxide, 3-hydroxyhexanoate, oxygenated octanoate, 4-hydroxybutyrate, hydroxydecanoate, 3-hydroxydodecanoate, 3-hydroxy-2-methylbutyrate, 3-hydroxy-2-methylvalerate, or 3-hydroxypropionate as a monomer of the PHA.

18. The system of claim 17, wherein the PHA is selected from the group consisting of poly(3-hydroxybutyrate), poly(3-hydroxybutyrate-co-3-hydroxyvalerate), poly(3-hydroxybutyrate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

19. The system of claim 15, wherein the polylactic acid has an average molecular weight in a range of from about 1.5×10⁵ Daltons to about 1.7×10⁵ Daltons.

20. The system of claim 15, wherein a first thickness of the adsorbent layer is in a range of from about 0.5 millimeters (mm) to about 20 mm, and a second thickness of the base layer is in a range of from about 0.1 mm to about 10 mm.
